(19) United States
(12) Patent Application Publication
(10) Pub. No.: US 2009/0099728 A1
(43) Pub. Date: Apr. 16, 2009

(54) CONTROL APPARATUS FOR AVOIDING COLLISION

(75) Inventors: Masanori ICHINOSE, Tsukuba (JP); Makoto YAMAKADO, Tsuchiura (JP); Masato ABE, Machida (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/251,956

(22) Filed: Oct. 15, 2008

(30) Foreign Application Priority Data
Oct. 16, 2007 (JP) 2007-268497

(51) Int. Cl. G08G 1/16; B60G 17/018; B60T 7/12; G05D 3/20; B60W 30/08

(52) U.S. Cl. 701/39; 701/301; 701/83; 701/92

(57) ABSTRACT

A collision avoiding control apparatus has a side acceleration command calculator unit for calculating a side acceleration command by judging whether an obstacle is to be avoided, by calculating a distance of the obstacle capable of being avoided, in accordance with a distance and width of the obstacle in front of a vehicle and a vehicle speed, and if it is judged that the obstacle is to be avoided, calculating a side acceleration necessary for a vehicle side motion amount to satisfy the width, in accordance with the distance and width and the vehicle speed, and a steering angle calculator unit for calculating in a predictable manner a vehicle steering angle from the side acceleration command calculated by the side acceleration command calculator unit.

### BACKGROUND OF THE INVENTION

The present invention relates to a collision avoiding control apparatus of vehicle which is capable of securely avoiding collision by twisting a vehicle if collision with a front obstacle cannot be avoided by decelerating.

As a conventional collision avoiding control apparatus for avoiding collision of a vehicle by steering in a state that there is a possibility of collision with an obstacle near the vehicle, a collision avoiding control apparatus is known which avoids collision with an object by setting a target pass position in a collision avoiding path and outputs to a steering controller a target steering angle which is a vehicle running parameter obtained from a Vehicle Dynamics Motion Model using the target pass position (e.g., refer to JP-A-2005-173663). According to JP-A-2005-173663, the target pass position is determined from a distance to the obstacle and a vehicle speed, and the steering angle is determined on the assumption that a running locus passing the target pass position is an arc, to thereby support steering for avoiding collision.

### SUMMARY OF THE INVENTION

According to the above-described conventional techniques, it is necessary to define in advance several target pass positions of a vehicle and running paths passing the target pass positions and to calculate a steering angle command value for following each running path by using a vehicle running model built-in a controller. Therefore, although path guidance can be conducted at higher precision, it takes a long process time to start control by determining all pass points and running paths after an obstacle is detected. Furthermore, in order to control running following the specified running path, it is necessary to perform feedback control of a vehicle running state. There is therefore an issue that a steering angle cannot be determined before starting collision avoidance, and that if there is a large delay time of a steering actuator, a sufficient collision avoidance performance cannot be exhibited.

It is an object of the present invention to provide a collision avoiding control apparatus capable of realizing secure collision avoidance by twisting a vehicle if collision with a front obstacle cannot be avoided by decelerating, and performing collision avoiding control by a simple method without degrading safety by reducing a calculation load of the collision avoiding control.

In order to achieve the above-described object, a collision avoiding control apparatus of the present invention including an obstacle detector unit for detecting whether or not an obstacle is present in a predetermined area in front of a vehicle, a vehicle state sensor for measuring a vehicle state, and a control unit for executing a collision avoiding operation for danger avoidance in accordance with a detection result by the obstacle detector unit, comprises: a side acceleration command calculator unit for calculating a side acceleration command by judging whether the obstacle is to be avoided, by calculating a distance capable of avoiding the obstacle in accordance with a distance and width of the obstacle in front of the vehicle obtained by the obstacle detector unit and a vehicle speed obtained by the vehicle state sensor, and if it is judged that the obstacle is to be avoided, by calculating a side acceleration necessary for a vehicle side motion amount to satisfy the width, in accordance with the distance and width and the vehicle speed; and a steering angle calculator unit for calculating a vehicle steering angle in a predictable manner from the side acceleration command calculated by the side acceleration command calculator unit, wherein if it is judged that a collision with the obstacle could occur, the collision avoiding operation is executed for danger avoidance.

A collision avoiding control apparatus of the present invention including an obstacle detector unit for detecting whether or not an obstacle is present in a predetermined area in front of a vehicle, a vehicle state sensor for measuring a vehicle state, and a control unit for executing a collision avoiding operation for danger avoidance in accordance with a detection result by the obstacle detector unit, comprises: a side acceleration command calculator unit for calculating a side acceleration command by judging whether the obstacle is to be avoided, by calculating a distance capable of avoiding the obstacle in accordance with a distance and width of the obstacle in front of the vehicle obtained by the obstacle detector unit and a vehicle speed obtained by the vehicle state sensor, and if it is judged that the obstacle is to be avoided, by calculating a first side acceleration necessary for a vehicle side motion amount to satisfy the width, a second side acceleration having a direction opposite to a direction of the first side acceleration and a distance to a point at which the first and second side accelerations are switched, in accordance with the distance and width and the vehicle speed; and a steering angle calculator unit for calculating a vehicle steering angle in a predictable manner from the side acceleration command calculated by the side acceleration command calculator unit, wherein if it is judged that a collision with the obstacle could occur, the collision avoiding operation is executed for danger avoidance.

The collision avoiding control apparatus described above may further comprise a yaw moment control unit for judging whether the vehicle is in an instable state, in accordance with the vehicle state amount obtained by the vehicle state sensor, and if it is judged that the vehicle is in the instable state, controlling a yaw moment generator unit by calculating a yaw moment necessary for recovering a stable state.

In the collision avoiding control apparatus described above, it is judged whether a road friction coefficient is large or small, in accordance with the vehicle state amount obtained by the vehicle state sensor, and if it is judged that the road friction coefficient is small, the distance capable of avoiding the obstacle for judging the obstacle is to be avoided, may be elongated in accordance with a ratio of reducing a braking power capable of being generated in the vehicle.

In the collision avoiding control apparatus described above, it is judged whether a road friction coefficient is large or small, in accordance with the vehicle state amount obtained by the vehicle state sensor, and if it is judged that the road friction coefficient is small, a magnitude of the side acceleration necessary for satisfying the width may be limited in accordance with a ratio of reducing the side acceleration capable of being generated in the vehicle.

In the collision avoiding control apparatus described above, it is judged whether a road friction coefficient is large or small, in accordance with the vehicle state amount obtained by the vehicle state sensor, and if it is judged that the road friction coefficient is small, coefficients of a calculation formula to be used by the steering angle calculator unit or a numerical map to be referred may be switched. Alternatively, it is judged whether a road friction coefficient is large or small, in accordance with a magnitude of a steering reaction force of a steering device of the vehicle, and if it is judged that the road friction coefficient is small, coefficients of a calculation formula to be used by the steering angle calculator unit or a numerical map to be referred may be switched.

The collision avoiding control apparatus of the present invention is equipped with the steering angle calculator unit which uses the side acceleration most directly defining a side motion amount, as a command value for urgent avoidance by steering, and calculates a steering angle directly from the side acceleration. It is therefore possible to determine the steering angle in a predictable manner. There is therefore an advantage that urgent collision avoiding control can be realized in a feed forward way and ensure collision avoidance can be realized with a simpler structure than that of a conventional example defining collision avoidance paths in advance.

In the collision avoiding control apparatus of the present invention, in addition to the first side acceleration for defining a side motion for avoiding collision with an obstacle, the second side acceleration having a direction opposite to that of the first side acceleration is applied to the vehicle. It is therefore possible to control to make the side direction motion speed be zero at the end of a collision avoiding operation. There is therefore an advantage that the vehicle posture can be controlled to recover the initial motion direction at the end of the collision avoiding operation.

In the collision avoiding control apparatus of the present invention, an unstable state of a vehicle is judged in accordance with a vehicle state amount obtained by the vehicle state sensor, particularly a vehicle yaw rate, e.g., in accordance with a reference yaw rate obtained from a steering angle and a vehicle speed, and a corresponding yaw moment is generated. There is therefore an advantage that a stable state of the vehicle can be recovered.

In the collision avoiding control apparatus of the present invention, it is judged whether the road friction coefficient is large or small, in accordance with a vehicle state amount obtained by the vehicle state sensor, particularly a wheel velocity and front and rear accelerations, e.g., in accordance with a calculated slip ratio of each drive wheel, and a largest deceleration the vehicle can generate and a corresponding distance capable of avoiding an obstacle collision are calculated. There is therefore an advantage that whether collision avoidance is possible can be judged more precisely.

In the collision avoiding control apparatus of the present invention, it is judged whether the road friction coefficient is large or small, in accordance with a vehicle state amount obtained by the vehicle state sensor, particularly a wheel velocity and front and rear accelerations, e.g., in accordance with a calculated slip ratio of each drive wheel or the like, and a largest side acceleration the vehicle can generate is calculated to limit a magnitude of the side acceleration command value. There is therefore an advantage that more precise collision avoiding control can be performed.

In the collision avoiding control apparatus of the present invention, it is judged whether the road friction coefficient is large or small, in accordance with a vehicle state amount obtained by the vehicle state sensor, particularly a wheel velocity and front and rear accelerations, e.g., in accordance with a calculated slip ratio of each drive wheel or the like, and coefficients of a formula to be used by the steering angle calculator unit or a numerical map to be referred is switched. There is therefore an advantage that a precise steering angle suitable for a road state can be calculated.

In the collision avoiding control apparatus of the present invention, it is judged whether the road friction coefficient is large or small, in accordance with comparison between a load torque under steering by a steering actuator and a reference steering load torque corresponding to a steering angle, and coefficients of a formula to be used by the steering angle calculator unit or a numerical map to be referred is switched. There is therefore an advantage that a precise steering angle suitable for a road state can be calculated.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the overall structure of an embodiment apparatus using a collision avoiding control apparatus for obstacle collision avoidance.

FIG. 2 is a diagram showing a flow of obstacle collision avoidance by the collision avoiding control apparatus.

FIG. 3 is a diagram showing friction characteristics of a tire.

FIG. 4 is a flow chart illustrating obstacle collision avoidance processes to be executed by the collision avoiding control apparatus.

### DESCRIPTION OF THE EMBODIMENTS

Description will now be made on embodiments by referring to the accompanying drawings.

### First Embodiment

The structure of the first embodiment will be described first.

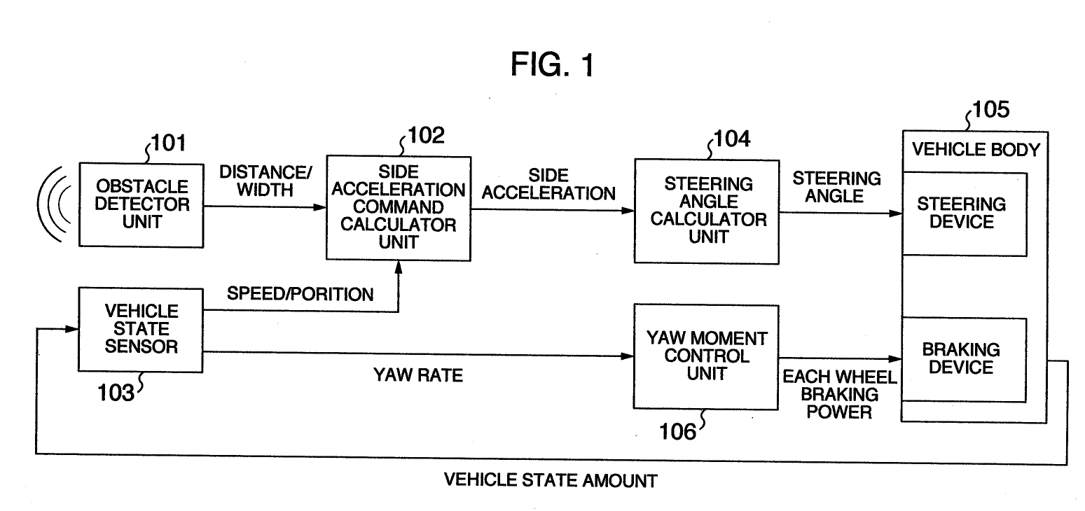

FIG. 1 is a diagram showing the overall structure of a collision avoiding control apparatus. A collision avoiding control apparatus for avoiding collision with an obstacle in front of a vehicle will be described by way of example.

An obstacle detector unit 101 measures a distance and width of a front obstacle. The obstacle detector unit 101 is considered to be mainly a radar such as a laser radar and a millimeter wave radar, an obstacle detector camera or the like. An obstacle distance detecting method is not specifically limited. In accordance with the distance to the front obstacle measured with the obstacle detector unit 101, a relative speed obtained through time differentiation of the distance or a vehicle velocity measured with a vehicle state sensor 103, a side acceleration command calculator unit 102 judges first a collision danger. A collision danger judging method judges, for example, whether deceleration can be completed without contacting the front obstacle if deceleration the vehicle can take is applied at the present distance of the front obstacle and the present relative speed. For example, this judgment is conducted by comparison between an obstacle distance Lr and a braking distance for vehicle stop (Vr²/2·ax) where Lr is an obstacle distance, Vr is a relative speed, and ax is a deceleration the vehicle can generate (e.g., a value preset as an upper limit of a deceleration the vehicle can generate during automatic braking). If the obstacle distance Lr is shorter than the braking distance, i.e., if Lr<(Vr²/2·ax), it is judged that the deceleration cannot be completed without a front obstacle contact. If the side acceleration command calculator unit 102 judges that the deceleration cannot be completed without the front obstacle contact, then the side acceleration command calculator unit calculates a side acceleration speed command corresponding to a side direction motion amount in order to move the vehicle in the side direction to avoid collision. A time Ta required for the vehicle to arrive at the obstacle position is given by:

Ta=(Vr−(Vr²−2·ax)^{1/2})/ax (1)

A side motion amount to be achieved before the arrival time Ta corresponds to the width W of the front obstacle measured with the obstacle detector unit 101. A side acceleration ay necessary for this side motion is given by:

ay=2·W/Ta² (2)

Therefore, if the vehicle can generate the side acceleration command value ay, contact with the obstacle can be avoided.

Next, the side acceleration command value ay calculated by the side acceleration command value calculator unit 102 in the manner described above is input to a steering angle calculator unit 104 which in turn calculates a steering angle δ. The steering angle calculator unit 104 uses an inverse method as the algorithm for calculating a necessary steering angle δ at the given side acceleration command value ay in a feed forward manner. Namely, a vehicle running equation is solved regarding the steering angle δ to calculate the steering angle δ directly from the side acceleration command value ay.

The vehicle running equation for a side slip motion is given by:

m·ay=−2·Kf·βf−2·Kr·βr (3)

where m is a vehicle weight, Kf and Kr are front and rear cornering powers, and βf and βr are front and rear side slip angles. In addition, the following equations are satisfied by the geometrical relation:

βf=β+lf·γ/V−δ (4)

βr=β−lr·γ/V (5)

where β is a vehicle side slip angle, lf and lr are center of gravity distances between front and rear wheels, and γ is a yaw rate.

By substituting the equations (4) and (5) into the equation (3), a side slip motion equation is given by:

δ=(1/2·Kf)(m·ay+2(Kf+Kr)β+2(lf·Kf−lr·Kr)γ/V) (6)

Similarly, a yaw motion equation is given by:

I·γ′=−2·lf·Kf·βf+2·Lr·Kr·βr (7)

By solving these equations, the following equations are obtained:

I·γ′+2·lr·Kr(lf+lr)γ/V−2·Kr(lf+lr)β=lf·m·ay (8)

V(β′+γ)=ay (9)

By substituting an ay value to these equations, β and γ can be obtained, and δ can be calculated from the equation (6).

If the vehicle runs on a road and the avoidance width W is sufficiently wider relative to the distance Lr, it may roughly approximated to β=γ=0 to directly calculate δ from the equation (6).

The front and rear cornering powers Kf and Kr in the vehicle running equations are coefficients changing nonlinearly with each wheel load so that approximate equations as the function of the deceleration ax may be used or a map to be referred by a deceleration ax actually measured may be used. An inverse model may be considered which calculates a necessary steering angle δ at a given side acceleration command value ay in a feed forward manner as in the above-described method. The method of calculating the steering angle δ from the side acceleration command value ay is not limited to the above-described method.

In this embodiment, the steering angle δ obtained in the feed forward manner described above is input as a command value to the steering device of the vehicle body 105 to perform steering control for collision avoidance. By directly using a side acceleration as a command value and providing an inverse model for a tire for calculating a steering angle directly from the side acceleration command value, it becomes possible to calculate a steering angle command value in a predicted manner and perform ensure collision avoiding control with a simple algorithm and without being influenced by a steering system delay or the like. With the control for determining the steering angle in the feed forward manner, if there is a displacement of the inverse model, particularly a model for front and rear cornering powers, from a real vehicle state, there is a possibility that a desired side acceleration cannot be obtained. However, since the side acceleration is used directly as the command value, it is easy to configure the steering angle calculator unit 104 in such a manner that a steering angle is finely adjusted so as to be coincident with the command value, by feeding back a side acceleration by using, for example, an acceleration sensor. It is possible to realize higher precision control by using an inexpensive sensor than a conventional yaw rate feedback method.

### Second Embodiment

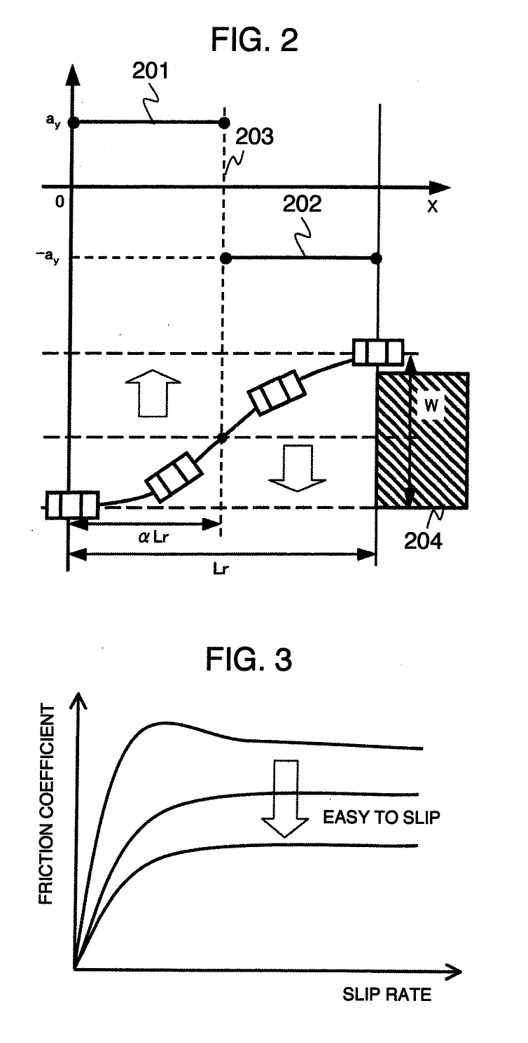

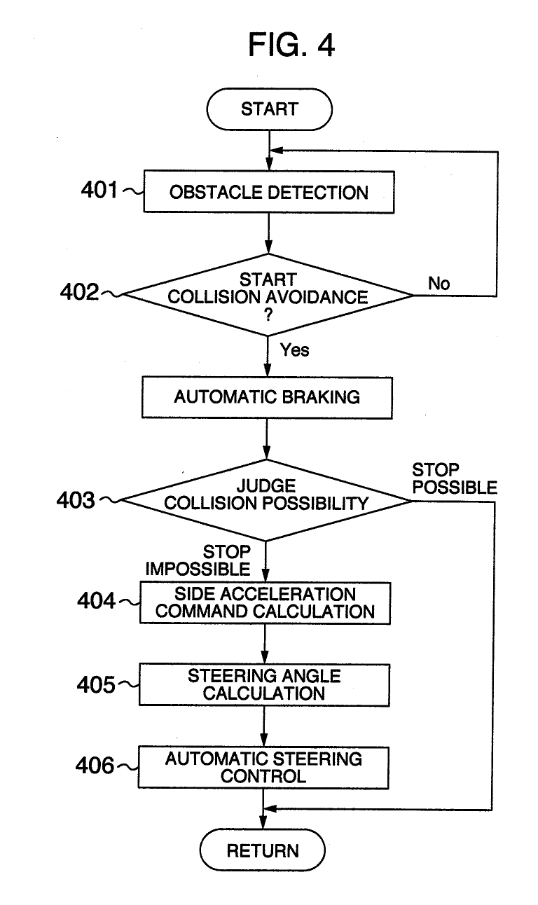

Next, the second embodiment will be described with reference to FIG. 2. FIG. 2 is a schematic diagram showing a flow of obstacle collision avoidance.

The first embodiment shows the collision avoiding method by which the side acceleration command value ay gives a side acceleration necessary for at least avoiding an obstacle collision through side motion by a width W of the obstacle, and does not consider at all a direction of the vehicle after the end of collision avoidance. Although it is sufficient if attention is paid to collision avoidance from the viewpoint of urgent collision avoidance, in urgent collision avoidance in actual road traffics, it is often convenient if an original motion direction of the vehicle is recovered at the end of collision avoidance.

In the second embodiment, therefore, collision avoiding control is performed in the following manner. As shown in FIG. 2, a first side acceleration command 201 necessary for avoiding a collision with an obstacle 204, and in addition a second side acceleration command 202 having a direction opposite to that of the first side acceleration command, necessary for setting a side speed to 0 at the end of collision avoidance of the vehicle started side direction acceleration, are used and a timing 203 for switching between the first and second side acceleration commands is calculated.

By representing a collision avoidance distance by Lr, and a first side acceleration by ay, and assuming that a side acceleration is switched at a timing α in terms of a distance ratio, a switching timing can be obtained by calculating α which satisfies both the condition that a sum of a value of ∫ay·dy calculated in a section 0→α·Lr and a value of ∫(−ay)·dy calculated in a section α·Lr→Lr becomes 0 and that a sum of second order integrations (distances) becomes equal to the obstacle width W.

By switching between the first side acceleration command satisfying the collision avoidance and the second side acceleration command having a direction opposite to that of the first side acceleration command, collision avoiding control becomes possible which realizes vehicle direction control of recovering the original motion direction at the end of collision avoidance.

### Third Embodiment

Next, the third embodiment will be described with reference again to FIG. 1.

As described earlier, in the collision avoiding control apparatus of the present invention, the obstacle detector unit 101 measures a distance and width of a front obstacle. In accordance with the distance to the front obstacle and a vehicle speed and the like measured with the vehicle state sensor 103, the side acceleration command calculator unit 102 firsts judges collision danger. If it is judged that a collision with the obstacle cannot be avoided, a side acceleration command corresponding to a side direction motion amount is calculated in order to move in a side direction for collision avoidance. In accordance with the side acceleration command value, the steering angle calculator unit 104 calculates a necessary steering angle in a feed forward way to control the steering device of the vehicle body 105.

In steering in the feed forward way, there may arise an error of a vehicle yaw rate to be caused by a difference between the inverse model and actual vehicle. It may be considered that a yaw rate measured with the vehicle state sensor 103 is input to the yaw moment control unit 106 and fed back to stabilize the vehicle body 105. For example, the yaw moment control unit 106 calculates a reference vehicle yaw rate by providing a vehicle running model, and performs running control so as to make the reference yaw rate be coincident with an actual yaw rate to thereby stabilize the vehicle body 105.

As an approach to coincidence control of the reference yaw rate and an actual yaw rate, an approach may be considered in which an error between the reference yaw rate and an actual yaw rate is multiplied by a gain to calculate a correction yaw moment necessary for the vehicle body 105, and the correction yaw moment is distributed to the braking device of the vehicle body 105 with a difference between right and left correction yaw moments to control the vehicle body. In this manner, a desired correction yaw moment is generated. In the urgent collision avoidance state, the running state should be in a normal braking state. Therefore, even if the correction yaw moment is generated, the running state of the vehicle body is not influenced so much by changing the right and left distribution ratio of the braking torque. Furthermore, since the actuator necessary for the vehicle is the same as that used by general ABS and a side slip preventing device, there is an advantage that a cost of realizing this control is very small.

### Fourth Embodiment

Next, the fourth embodiment will be described in detail.

In the urgent collision avoidance state when a front obstacle is detected with the obstacle detector unit 101, urgent braking is performed first. Therefore, by measuring a wheel velocity in the braking state with the vehicle state sensor 103, estimating a braking torque, measuring a braking acceleration, or by other methods, it becomes possible to know a change in a slip ratio and a road friction coefficient.

FIG. 3 is a diagram showing friction characteristics of a tire. The abscissa represents a flip factor which has a ratio of (V−Vt)/V where V is a vehicle speed, and Vt is a wheel velocity. The slip ratio can therefore be obtained from this formula by measuring a wheel velocity during braking and estimating a vehicle speed by an observer. On the other hand, a friction coefficient can be obtained by estimating a braking torque during braking or measuring a deceleration. The road state can therefore be estimated by applying these factors to the graph of FIG. 3. In this manner, a limit of deceleration during braking can be estimated. By reflecting this road state upon a judgment algorithm for judging whether collision avoidance can be conducted only by the control described in the above embodiments, it becomes possible to realize collision avoidance possibility judgment more suitable for an actual road state.

### Fifth Embodiment

Next, the fifth embodiment will be described.

The fourth embodiment describes one example of the methods of estimating a road state in accordance with a vehicle state amount obtained by the vehicle state sensor 103. In the fifth embodiment, in accordance with an estimated road state, a limit of a side acceleration obtained by steering can be estimated. By setting an upper limit value by reflecting this road state upon a side acceleration command value output from the side acceleration command calculator unit 102 described in the above embodiments, it becomes possible to realize collision avoidance more suitable for an actual road state.

### Sixth Embodiment

Next, the sixth embodiment will be described in detail. The fourth embodiment described above shows an example of the methods of estimating a road state in accordance with a vehicle state amount obtained by the vehicle state sensor 103. In the sixth embodiment, since a change in the tire characteristics can be estimated from the estimated road state, the cornering powers obtained by using the steering angle calculation algorithm of the steering angle calculator unit 104 described in the above embodiments can be reflected upon steering angle calculation through map switching or through coefficient switching for determining an approximation formula of cornering powers, respectively in accordance with the road state. Therefore, it becomes possible to realize collision avoidance more suitable for an actual road state

### Seventh Embodiment

Next, the seventh embodiment will be described in detail. The fourth embodiment shows an example of the methods of estimating a road state in accordance with a vehicle state amount. In the seventh embodiment, a road state is estimated in accordance with an amplitude of a steering reaction force formed during automatic steering. During steering, a rotation torque having an approximately proportional relation with a steering angle is generated. This torque is called a self aligning torque. A steering system mechanism receives a reaction force of moving back the steering, by the self aligning torque. This self aligning torque changes with a road friction coefficient so that the road state can be estimated by measuring this steering reaction force. The cornering powers obtained by using the steering angle calculation algorithm of the steering angle calculator unit 104 described in the above embodiments can be reflected upon steering angle calculation through map switching or through coefficient switching for determining an approximation formula of cornering powers, respectively in accordance with the road state. Therefore, it becomes possible to realize collision avoidance more suitable for an actual road state

The embodiments for reducing the present invention in practice have been described above. The specific structures of the present invention are not limited only to the above-described embodiments, but the present invention includes also modifications and the like not departing from the gist of the present invention.

1. A collision avoiding control apparatus including an obstacle detector unit for detecting whether or not an obstacle is present in a predetermined area in front of a vehicle, a vehicle state sensor for measuring a vehicle state, and a control unit for executing a collision avoiding operation for danger avoidance in accordance with a detection result by said obstacle detector unit, the collision avoiding control apparatus comprising:
a side acceleration command calculator unit for calculating a side acceleration command by judging whether said obstacle is to be avoided, by calculating a distance capable of avoiding said obstacle in accordance with a distance and width of said obstacle in front of the vehicle obtained by said obstacle detector unit and a vehicle speed obtained by said vehicle state sensor, and if it is judged that said obstacle is to be avoided, by calculating a side acceleration necessary for a vehicle side motion amount to satisfy said width, in accordance with said distance and width and said vehicle speed; and
a steering angle calculator unit for calculating a vehicle steering angle in a predictable manner from the side acceleration command calculated by said side acceleration command calculator unit,
wherein if it is judged that a collision with said obstacle could occur, the collision avoiding operation is executed for danger avoidance.

2. A collision avoiding control apparatus including an obstacle detector unit for detecting whether or not an obstacle is present in a predetermined area in front of a vehicle, a vehicle state sensor for measuring a vehicle state, and a control unit for executing a collision avoiding operation for danger avoidance in accordance with a detection result by said obstacle detector unit, the collision avoiding control apparatus comprising:
a side acceleration command calculator unit for calculating a side acceleration command by judging whether said obstacle is to be avoided, by calculating a distance capable of avoiding said obstacle in accordance with a distance and width of said obstacle in front of the vehicle obtained by said obstacle detector unit and a vehicle speed obtained by said vehicle state sensor, and if it is judged that said obstacle is to be avoided, by calculating a first side acceleration necessary for a vehicle side motion amount to satisfy said width, a second side acceleration having a direction opposite to a direction of said first side acceleration and a distance to a point at which said first and second side accelerations are switched, in accordance with said distance and width and said vehicle speed; and
a steering angle calculator unit for calculating a vehicle steering angle in a predictable manner from the side acceleration command calculated by said side acceleration command calculator unit,
wherein if it is judged that a collision with said obstacle could occur, the collision avoiding operation is executed for danger avoidance.

3. The collision avoiding control apparatus according to claim 1, further comprising a yaw moment control unit for judging whether said vehicle is in an instable state, in accordance with the vehicle state amount obtained by said vehicle state sensor, and if it is judged that said vehicle is in the instable state, controlling a yaw moment generator unit by calculating a yaw moment necessary for recovering a stable state.

4. The collision avoiding control apparatus according to claim 1, wherein:
it is judged whether a road friction coefficient is large or small, in accordance with the vehicle state amount obtained by said vehicle state sensor, and if it is judged that said road friction coefficient is small, said distance capable of avoiding said obstacle for judging said obstacle is to be avoided, is elongated in accordance with a ratio of reducing a braking power capable of being generated in the vehicle.

5. The collision avoiding control apparatus according to claim 1, wherein:
it is judged whether a road friction coefficient is large or small, in accordance with the vehicle state amount obtained by said vehicle state sensor, and if it is judged that said road friction coefficient is small, a magnitude of said side acceleration necessary for satisfying said width is limited in accordance with a ratio of reducing said side acceleration capable of being generated in the vehicle.

6. The collision avoiding control apparatus according to claim 1, wherein:
it is judged whether a road friction coefficient is large or small, in accordance with the vehicle state amount obtained by said vehicle state sensor, and if it is judged that said road friction coefficient is small, coefficients of a calculation formula to be used by said steering angle calculator unit or a numerical map to be referred is switched.

7. The collision avoiding control apparatus according to claim 1, wherein:
it is judged whether a road friction coefficient is large or small, in accordance with a magnitude of a steering reaction force of a steering device of the vehicle, and if it is judged that said road friction coefficient is small, coefficients of a calculation formula to be used by said steering angle calculator unit or a numerical map to be referred is switched.
